(19) United States
(12) Patent Application Publication
(10) Pub. No.: US 2022/0103523 A1
(43) Pub. Date: Mar. 31, 2022

(54) ESTABLISHING A SECURE INTERNET CONNECTION BETWEEN AN ENDPOINT AGENT AND A CLOUD-BASED SECURITY SERVICE

(71) Applicant: Fortinet, Inc., Sunnyvale, CA (US)

(72) Inventors: Michael C. Starr, Reston, VA (US); Gregory L. Galloway, Suwanee, GA (US)

(73) Assignee: Fortinet, Inc., Sunnyvale, CA (US)

(21) Appl. No.: 17/039,079

(22) Filed: Sep. 30, 2020

(51) Int. Cl. H04L 29/06

(52) U.S. Cl. CPC H04L 63/0272

(57) ABSTRACT

Systems and methods for establishing a secure connection between an endpoint agent and a cloud-based security service are provided. According to one embodiment, a DNS request is issued by an agent running on an endpoint device to a secure Internet connection service of a cloud-based security service that includes multiple pools of geographically distributed VPN servers. A DNS response to the DNS request is received containing an IP address of a particular VPN server within a pool of the multiple pools. The pool is selected by the secure Internet connection service based on a geographic location of the endpoint device inferred by a source IP address of the DNS request. The particular VPN server is selected from multiple VPN servers in the pool based on its status. A secure Internet connection is established between the agent and the particular VPN server via a particular logical port.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2020, Fortinet, Inc.

### BACKGROUND

### Field

Embodiments of the present invention generally relate to an endpoint device security. In particular, embodiments of the present invention relate to a secure Internet connection between an endpoint device and a cloud-based security service that provides autonomous, geographically relevant network overlay protection using real-time advanced cybersecurity controls.

### Description of the Related Art

Endpoint devices need to be protected irrespective of whether they are connecting through a home network, corporate network, or are using public access points. Providing a consistent security posture and performant connection to the Internet and corporate resources for endpoint devices, for example, mobile and remote workforces, is increasingly becoming difficult. Cybersecurity concerns of enterprises get exacerbated by the adoption of Bring-Your-Own-Device policies when users are reticent to install corporate endpoint security agents. Additionally, when these endpoint devices go off the network, visibility into Internet activity and security events are lost.

An enterprise may install a virtual private network (VPN) agent at the endpoint device to route endpoint device network traffic through a secure channel to protect the endpoint devices from cyber-attacks and allow access to corporate resources. However, it has been observed that users of the endpoint devices are reluctant to use VPN services, as they find it cumbersome, slow down the internet connection speed and restrict access of many other services by applying corporate network security rules, even though the user is not trying to critical access corporate resources. As the endpoint devices don't use VPN, they might be exposed to cyber-attack and may be a potential sneak point for cyber attackers as they connect to the enterprise network later on.

### SUMMARY

Systems and methods for establishing a secure connection between an endpoint agent and a cloud-based security service are described. According to one embodiment, a domain name service (DNS) request is issued by an agent running on an endpoint device to a secure Internet connection service of a cloud-based security service. The secure Internet connection service includes multiple pools of geographically distributed virtual private network (VPN) servers. A DNS response to the DNS request is received containing an Internet Protocol (IP) address of a particular VPN server within a pool of the multiple pools. The pool is selected by the secure Internet connection service based at least in part on a geographic location of the endpoint device inferred by a source IP address of the DNS request. The particular VPN server is selected from multiple VPN servers in the pool based on a status of the particular VPN server. A secure Internet connection is established between the agent and the particular VPN server via a particular logical port.

Other features of embodiments of the present disclosure will be apparent from accompanying drawings and detailed description that follows.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description applies to any one of the similar components having the same first reference label irrespective of the second reference label.

FIG. 1 conceptually illustrates an enterprise network in which endpoint protection is provided through an endpoint agent in accordance with an embodiment of the present disclosure.

FIG. 2 illustrates functional modules of an endpoint agent configured to provide endpoint protection in accordance with an embodiment of the present disclosure.

FIG. 3 is a block diagram illustrating stateful monitoring of server health within a cloud-based security service in accordance with an embodiment of the present disclosure.

FIG. 4 is a block diagram illustrating an infrastructure to provide faster connectivity on behalf of users of a cloud-based security service in accordance with an embodiment of the present disclosure.

FIG. 5 is a block diagram illustrating functional modules of a VPN server selection service configured to intelligently select a VPN server in accordance with an embodiment of the present disclosure.

FIG. 6 is a block diagram illustrating functions performed by a VPN server in accordance with an embodiment of the present disclosure.

FIG. 7 is a flow diagram illustrating VPN port selection in accordance with an embodiment of the present disclosure.

FIG. 8 is a flow diagram illustrating a process followed by an endpoint agent to provide a secure Internet connection in accordance with an embodiment of the present disclosure.

FIG. 9 is a flow diagram illustrating a process involving both an endpoint agent and a secure Internet connection service to provide a secure Internet connection in accordance with another embodiment of the present disclosure.

FIG. 10 illustrates an exemplary computer system in which or with which embodiments of the present invention may be utilized.

### DETAILED DESCRIPTION

Systems and methods for establishing a secure connection between an endpoint agent and a cloud-based security service are described. Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present invention may be provided as a computer program product, which may include a non-transitory machine-readable storage medium embodying thereon instructions, which may be used to program the computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within the single computer) and storage systems containing or having network access to a computer program(s) coded in accordance with various methods described herein, and the method steps of the invention could be accomplished by modules, routines, subroutines, or subparts of a computer program product.

In the following description, numerous specific details are set forth in order to provide a thorough understanding of example embodiments. It will be apparent, however, to one skilled in the art that embodiments described herein may be practiced without some of these specific details

### Terminology

Brief definitions of terms used throughout this application are given below.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein, a “network security appliance” or a “network security device” generally refers to a device or appliance in virtual or physical form that is operable to perform one or more security functions. Some network security devices may be implemented as general-purpose computers or servers with appropriate software operable to perform one or more security functions. Other network security devices may also include custom hardware (e.g., one or more custom Application-Specific Integrated Circuits (ASICs)). A network security device is typically associated with a particular network (e.g., a private enterprise network) on behalf of which it provides the one or more security functions. The network security device may reside within the particular network that it is protecting, or network security may be provided as a service with the network security device residing in the cloud. Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Secure (IPSec), TLS, SSL), application control, Voice over Internet Protocol (VoIP) support, Virtual Private Networking (VPN), data leak prevention (DLP), antispam, antispyware, logging, reputation-based protections, event correlation, network access control, vulnerability management, and the like. Such security functions may be deployed individually as part of a point solution or in various combinations in the form of a unified threat management (UTM) solution. Non-limiting examples of network security appliances/devices include network gateways, VPN appliances/gateways, UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), and DoS attack detection appliances (e.g., the FORTIDDOS family of DoS attack detection and mitigation appliances).

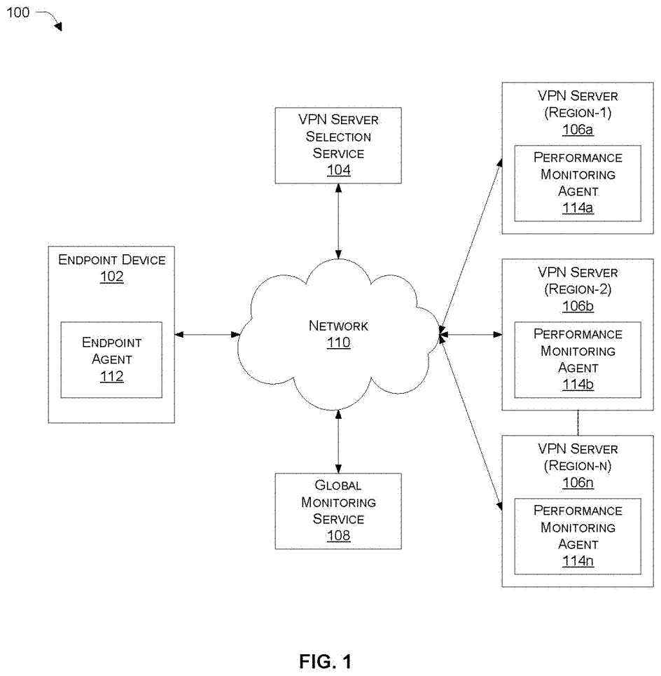

FIG. 1 conceptually illustrates an enterprise network 100 in which endpoint protection is provided through an endpoint agent in accordance with an embodiment of the present disclosure. An endpoint agent 112, which may also be referred to herein interchangeably as an agent, installed on or associated with the endpoint device 102 may ensure one or more security features (e.g., a secure Internet connection) are enabled on the endpoint device 102 when the endpoint device 102 is a untrusted network (e.g., a public network or public access point) for accessing the Internet.

Typically, VPN tools require a user to select a VPN server from a list of VPN servers and require authentication. Also, when the network changes, the user needs to repeat the exercise. Many users find it cumbersome and may forget to connect/disconnect to/from the VPN as appropriate. According to one embodiment, the agent 112 automatically maintains a secure Internet connection with a VPN server without requiring specific selection by the user and traditional authentication. When enabled, the agent 112 may automatically route network traffic to and from the endpoint device 102 through the secure Internet connection to a cloud-based security service associated with the VPN server. In an embodiment, the cloud-based security service may facilitate, among other things, monitoring of traffic and protecting the endpoint from malicious activities. As described further below, when the endpoint 102 is connected to the Internet via an untrusted network, for example, to access a resource of an organization that is a subscriber to the cloud-based security service, a secure Internet connection service (e.g., VPN server selection service 104) may facilitate the selection of an appropriate VPN server with which the endpoint device 102 establishes the secure Internet connection to achieve better performance.

In an embodiment, when the endpoint device 102 makes an outbound connection attempt, the agent 112 may intercept the connection attempt and initiate a domain name service (DNS) request through network 110 to a VPN server selection service 104 associated with the cloud-based security service. The VPN server selection service 104 may be associated with multiple pools of VPN servers in which each pool is associated with a particular geographic region. Each pool may have multiple VPN servers configured to work in a load-sharing manner to serve devices from the particular region. The VPN server selection service 104, on receipt of the DNS request from agent 112, creates a DNS response that includes an IP address of a particular VPN server and sends the DNS response to the agent 112. Based on the DNS response, agent 112 may establish the secure Internet connection between the endpoint 102 and the particular VPN server.

Although, for sake of simplicity, embodiments of the present disclosure are described with reference to a DNS response containing an IP address of a particular VPN server, it is to be appreciated that the DNS response may include multiple IP addresses and may also indicate an order of priority among the multiple IP addresses, each representing a VPN server of a set of VPN servers of a particular pool. In various embodiments, in order to avoid overloading any system with large DNS responses, for example, the number of IP addresses returned by the DNS response may be limited to a predetermined or configurable threshold (e.g., 5 to 15 IP addresses). In one embodiment, the predetermined or configurable threshold is 10 IP addresses.

In an embodiment, the service 104 may use a global monitoring service 108 to update the respective status of individual VPN servers. For example, the global monitoring service 108 may maintain an updated health status of the VPN server 106a located in region 1, VPN server 106b located in region 2, and VPN server 106n located in region-n. The global monitoring server 108 may send a status update request to each of the VPN servers located across different regions. In an embodiment, a stateful performance monitoring agent may be configured at each VPN server to actively monitor the status of the respective server and report the status to the global monitoring service 108. For example, a performance monitoring agent 114a may be configured at the VPN server 106a, a performance monitoring agent 114b may be configured at the VPN server 106b and a performance monitoring agent 114n may be configured at the VPN server 106n, respectively. Each of these agents 114a-n, may independently monitor the status of the respective VPN server and report the status to the global monitoring service 108 or directly to service 104. In an embodiment, based on the status monitored by a performance monitoring agent, a VPN server may pull itself out from a pool of available VPN servers if the health status of the VPN server does not meet a predefined threshold. For example, if the server identifies a high load, for example, on its compute, storage, memory, and/or bandwidth resources the server may pull itself out from the pool of available VPN servers. As those skilled in the art will appreciate a server health status may be based on these and/or other metrics/indicators (e.g., heartbeat of the server via periodic network pings, server logs, and server latency) In an embodiment, the service 104 receives the status of each of the plurality of VPN servers through stateful monitoring by the respective performance monitoring agent. The service 104 maintains the updated status of the each of the plurality of VPN servers based on status updates received from stateful daemon associated with each of the plurality of VPN servers.

The service 104 selects the particular VPN server from the plurality of VPN servers by actively monitoring the health status of each of the plurality of VPN servers available in a region and selecting the particular VPN server that is most suitable. The status of the particular server is determined based on any or combination of health status, country-specific compliance regulations (e.g., General Data Protection Regulation (GDPR) or other compliance rules), and status of connections with one or Internet service providers. The status of a particular VPN server may be determined based on a plurality of factors, including, but not limited to, a load on the particular VPN server, route congestion status from the endpoint device to VPN server, and a number of active VPN connection at the particular VPN server. According to one embodiment, the service 104 selects the pool based at least in part on a geographic location of the endpoint device 102 inferred by a source IP address of the DNS request, and select the particular VPN server from a plurality of VPN servers in the pool based on a status of the particular VPN server. For example, the pool may be selected by the secure Internet connection service based on the geographic location of the endpoint device 102 and a country-specific regulation or compliance rule applicable to the endpoint device 102 or a country-specific regulation or compliance rule applicable to the particular server.

On receiving the DNS response, the agent 112 establishes a secure Internet connection between the agent and the particular VPN server via a particular logical port. Once the secure Internet connection is established, the agent routes network traffic of the endpoint device through the secure Internet connection. To be transparent to the network from which the endpoint device 102 is connected, the endpoint device 102 may first attempt to use a default VPN port and may try other ports if the endpoint device 102 is not able to establish the secure Internet connection with the selected VPN server through the default VPN port. The agent 112 may attempt to use s different logical ports if the establishment of the secure Internet connection through the particular logical port is not successful. For example, the agent may select a logical port of a plurality of logical ports and make a connection attempt with the particular VPN server via the selected logical port until a connection attempt with the particular VPN server is successful. The agent may prioritizes one or more well-known VPN ports over other ports for establishing the secure Internet connection.

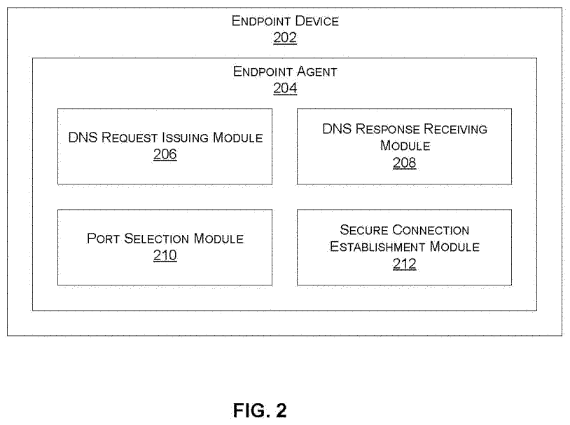

FIG. 2 illustrates functional modules of an endpoint agent 204 configured to provide endpoint protection in accordance with an embodiment of the present disclosure. The endpoint agent 202 (which represents a non-limiting example of endpoint agent 112) associated with an endpoint device 202 may include a DNS request issuing module 206 configured to issue a domain name service (DNS) request to a secure Internet connection service (e.g., VPN selection service 104) of a cloud-based security service, a DNS response receiving module 208 configured to receive a DNS response containing the IP address of a particular VPN server, and a secure connection establishment module 212 configured to establish a secure connection between the endpoint device 202 and the particular VPN server. In an embodiment, the endpoint agent 204 includes a port selection module 210 configured to initially use a default or well-known VPN port for establishing the secure Internet connection with the particular VPN server, and attempt other ports, including private ports, until a secure connection is established.

In an embodiment, the DNS request issuing module 206 is configured to issue the DNS request automatically when the agent determines that the endpoint device 202 is out of a secure network. Module 206 may issue a DNS request when a new connection request is attempted for access to Internet resources.

In an embodiment, the DNS response receiving module 208 of the agent 204 receives a DNS response to the DNS request containing an Internet Protocol (IP) address of a particular VPN server within a pool of the plurality of pools. The secure Internet connection service may be associated with multiple VPN servers located across different regions. The secure Internet connection service may select a pool of VPN servers from multiple VPNs servers based on the geographical location of the endpoint device 202 and may select the particular VPN server from the selected pool based on the status of the particular server. In an embodiment, a secure Internet connection service provides geographically relevant DNS response based on stateful monitoring of the status of each of the associated VPN servers. The service may select a VPN server from a pool of VPN servers of the region that is the best fit. In an embodiment, the secure Internet connection service may use a global monitoring system 304 (e.g., global monitoring service 108) to keep an updated status of each of the VPN servers.

In one embodiment, the agent 204 provides a secure Internet connection to the cloud-based security service through which network traffic originated by the endpoint device 202 is routed. Non-limiting examples of the cloud-based security service include but a secure access service edge (SASE) platform, a firewall as a service (FWaaS), an antivirus protection service, and an intrusion detection service. According to one embodiment, the cloud-based security service manages users, and Uniform Resource Locator (URL) filtering applies a standard set of unified threat management (UTM) profiles to all traffic and applies configuration to relevant data center locations using orchestration and automation platforms. The agent 204 may be configured to forward all traffic originating from the endpoint device 202 through the secure Internet connection established with the particular VPN server to the cloud-based security service. The agent 204 may also ensure a consistent security posture regardless of location an ensure suitable network performance even when network traffic is routed through the secure Internet connection. In an embodiment, the VPN servers may be configured to be co-located in data center clusters. The VPN server may be located in a network, having an established a peered connection with other Internet and/or cloud service providers to provide faster connectivity to such service providers on behalf of users of the cloud-based security service. The particular VPN server may route network traffic received from endpoint devices of subscribers through dedicated, highly peered backbone infrastructure.

In an embodiment, the agent 204 may be configured with the endpoint device 202 with simple email-based verification or device identity-based verification and, once configured, may not require any specific action by the user to establish a secure Internet connection. In an embodiment, the agent 204 may automatically detect an untrusted network and connect to the best fit VPN server available in the region.

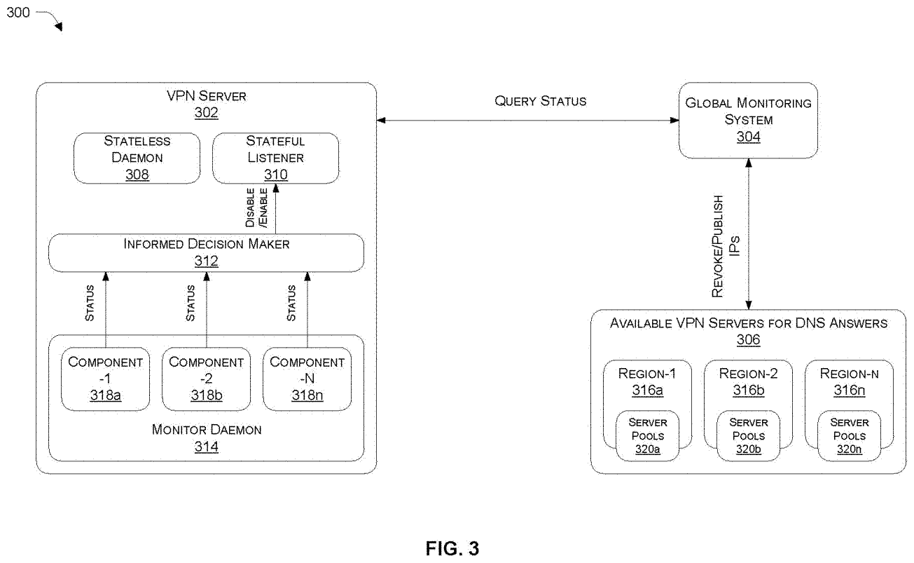

FIG. 3 is a block diagram illustrating stateful monitoring of server health within a cloud-based security service 300 in accordance with an embodiment of the present disclosure. In the context of the present example, a simplified view of a cloud-based security service 300 includes a VPN server 302, a global monitoring system 304, and available VPN servers for DNS answers 306. The global monitoring system 304 may query status of the VPN server 302 and update available VPN servers for DNS answers 306. In an embodiment, the VPN server 302 may include a stateless daemon 308 configured to receive status query requests and provide responses to the global monitoring system 304 with a current status of the VPN server 302.

In one embodiment, the VPN server 302 includes a stateless daemon 308, a stateful listener 310, an informed decision maker 312, and a monitor daemon 314. The stateful listener 310 may receive disable/enable instruction from informed decision maker 312. The informed decision-maker 312 may generate the disable or enable instruction based on status updates received from the monitor daemon 314 regarding the status of various components 318a-n of the VPN server 302. The components 318a-n may include compute, storage, memory, and/or bandwidth resources. The VPN server 302 may pull itself out from those identified by the available VPN servers 306 if it receives a disable instruction from the informed decision maker 312, for example, as a result of one or more of components 318a-n not being in a healthy condition or estimated to be overloaded. When resource utilization of any or combination of components 318a-n exceeds a predefined individual threshold or collective resource utilization threshold, the VPN server 302 may pull itself out from the pool of available servers 306. In an embodiment, the global monitoring system 304 may similarly exclude the VPN server 302 from the pool of available VPN servers 306 if the status update indicates that the resources of VPN server 302 are utilized in excess of a given threshold. The global monitoring system 304 may maintain the pool of available VPN servers 306. The pool of available VPN servers 306 may maintain separate server pools 320a-n for each region 316a-n, respectively. In the context of the present example, a server pool 320a is maintained for region 316a, a server pool 320b is maintained for region 316b, and server pool 320n is maintained for region-n 316n.

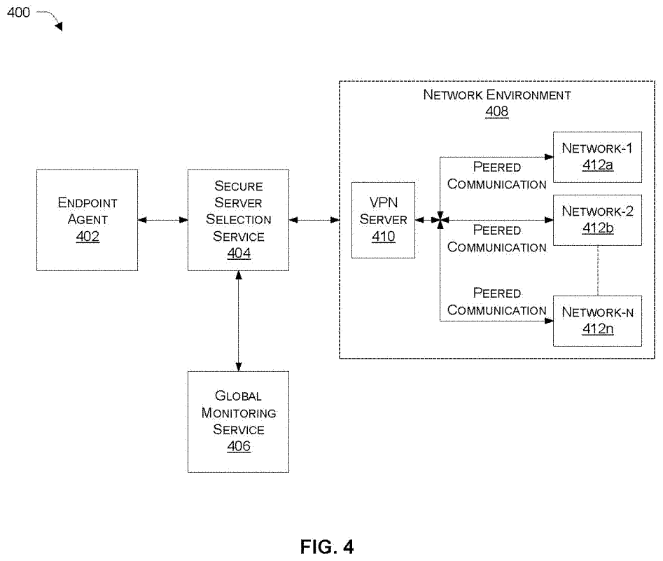

FIG. 4 is a block diagram illustrating an infrastructure 400 to provide faster connectivity on behalf of users of a cloud-based security service in accordance with an embodiment of the present disclosure. As shown in FIG. 4, when an endpoint agent 402 running on an endpoint device issues a DNS request for connecting to a VPN server, a secure server selection service 404 may consult the global monitoring service 406 to identify a pool of VPN servers based on the location of the endpoint device and select a particular VPN server (e.g., VPN server 410) based on the status of the VPN server 410. The secure server selection service 404 selects the VPN server 410 or set of VPN servers that is/are geographically relevant to the endpoint device and is in good condition. In an embodiment, the secure server selection service 404 may also refers to one or more country-specific compliance requirements and selects the server 410 that is known to meet such requirements (e.g., GDPR requirements). On receipt of the DSN response from the secure server selection service 404, the endpoint agent 402 may establish a secure Internet connection between the endpoint device and the cloud-based security service. In an embodiment, to ensure faster connectivity, the VPN server 410 may route network traffic associated with the endpoint device 402 through a peered connection with other networks 412a-n. In an embodiment, the VPN server 410 may be co-located within the same network environment 408 in which many of the popular internet service providers and/or cloud service providers co-exist.

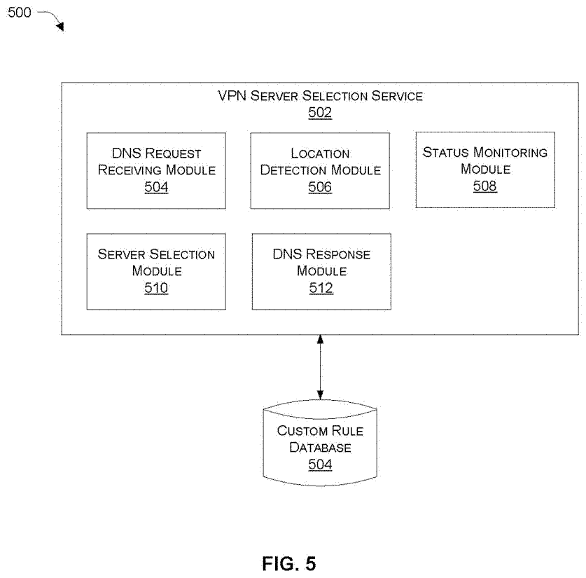

FIG. 5 is a block diagram 500 illustrating functional modules of a VPN server selection service configured to intelligently select a VPN server in accordance with an embodiment of the present disclosure. A VPN server selection service 502 may run within a dedicated computing device or in a cloud environment and use different processing resources to perform the intended actions described below. The service 502 may be associated with a global monitoring service and maintain a plurality of pools of geographically distributed virtual private network (VPN) servers. A VPN server selection service 502 may include a DNS request receiving module (not shown) configured to receive a DNS request from an agent running on an endpoint device, a DNS response module (not shown) configured to send a DNS answer/response to the DNS request containing an Internet Protocol (IP) address of a particular VPN server selected from a pool of the plurality of pools of VPN servers.

The service 502 includes a location determination module 506 configured to detect the location of the endpoint device. Module 506 may infer the location of the endpoint device based on the IP address associated with the DNS request. The service 502 includes a status monitoring module 508 configured to evaluate the status of each of the VPN servers using a global monitoring service that uses stateful monitoring to collect status from each of the VPN servers and maintain a pool of available VPN servers for each region. The service 502 further includes a server selection module 510 configured to select a pool from the plurality of VPN servers based on the determined location of the endpoint device and select a particular VPN server from the selected pool based on the status of the VPN servers of the selected pool. In an embodiment, the server selection module 510 may refer to a custom rule database 504, which may maintain VPN selection rules to select the particular VPN server. The rules may include location-specific (e.g., country-specific) compliance rules, device type-specific rules, and application-specific rules.

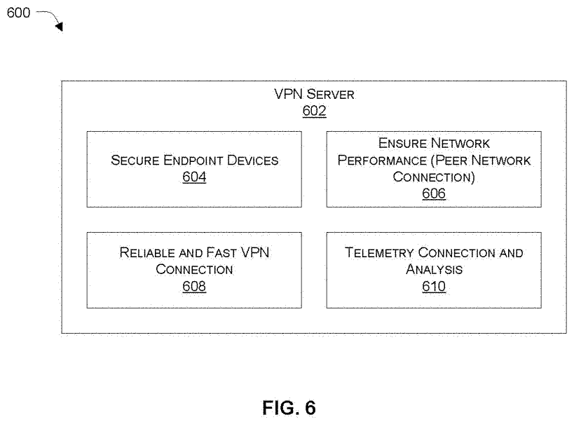

FIG. 6 is a block diagram 600 illustrating functions performed by a VPN server 602 in accordance with an embodiment of the present disclosure. As shown in FIG. 6, the VPN server 602, which may be a dedicated device or configured in a cloud environment, may use processing resources associated with it to perform one or more actions described below. The VPN server 602 may be configured to route network traffic of endpoint devices connected through a secure Internet connection to ensure they are secure, as shown at block 604. The VPN server 602 may ensure network performance, as shown at block 606, by routing the network traffic through highly peered network connections with other networks. The VPN server 602 may provide reliable and fast VPN connection, as shown at block 608. As one may appreciate, the VPN server 602 ensures a reliable connection as it is connected to the endpoint devices only when it is in good health and compliant to custom rules. The VPN server 602 facilitates a fast connection with help highly peered backbone infrastructure.

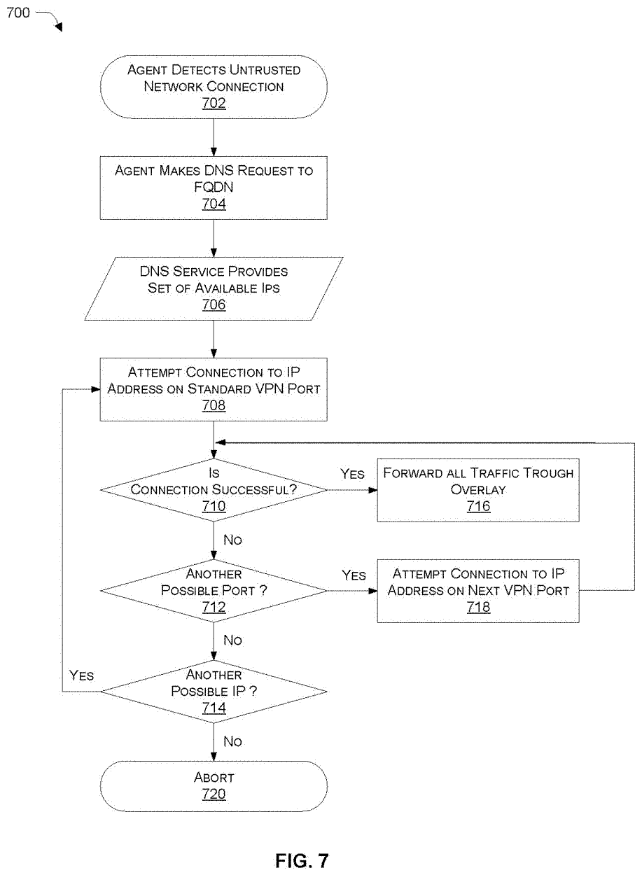

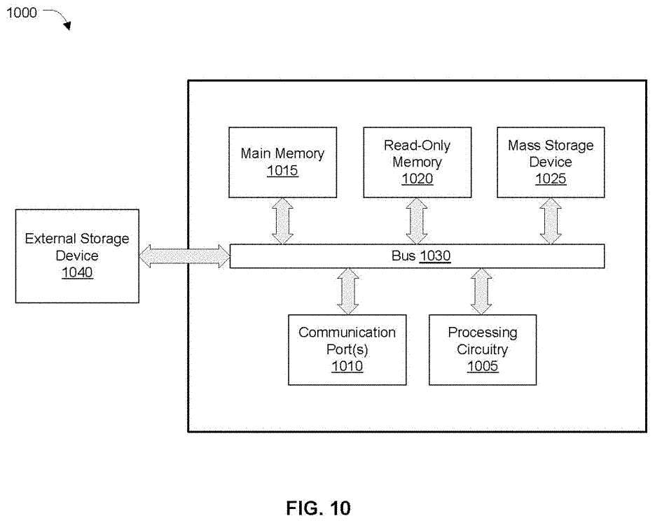

The various modules, services, and agents described herein and the processing described below with reference to the flow diagrams of FIGS. 7-9 may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, the processing may be performed by one or more virtual or physical computer systems of various forms, such as the computer system described with reference to FIG. 10 below.

FIG. 7 is a flow diagram illustrating VPN port selection in accordance with an embodiment of the present disclosure. As shown in FIG. 7, an agent detects an untrusted network connection, as shown at block 702, and makes a DNS request to a fully qualified domain name (FQDN) as shown at block 704. In an embodiment, a DNS service (e.g., associated with a secure Internet connection service provided by a cloud-based security service) may provide a set of one or more available IPs, as shown at block 706 to the agent. Each IP address indicates a VPN server. The service may provide the set of IP addresses for a set of VPN server may located in the same region as the endpoint device or that may otherwise be closest to the endpoint device. As described above, the DNS service may provide the set of IP addresses by selecting a set of one or more particular VPN servers based on the location and status of the particular VPN servers. On receiving the set of IP addresses, the agent attempts to connect to a first IP address of the set of IP addresses through a standard port (well-known port, or default VPN port), as shown at block 708. If the connection is successful, as shown at block 710, the agent forwards all traffic through the overlay, as shown at block 716. If the connection through the standard port is not established, the agent checks if another possible port is available, as shown at block 712, and attempts a connection to the first IP address through the next VPN port, as shown at block 718. In an embodiment, if no other port is available, the agent checks if another IP of the set of IPs remains, and attempts a connection with the next IP if available, as shown at block 714. If no additional IP address is available, the process is aborted, as shown at block 720.

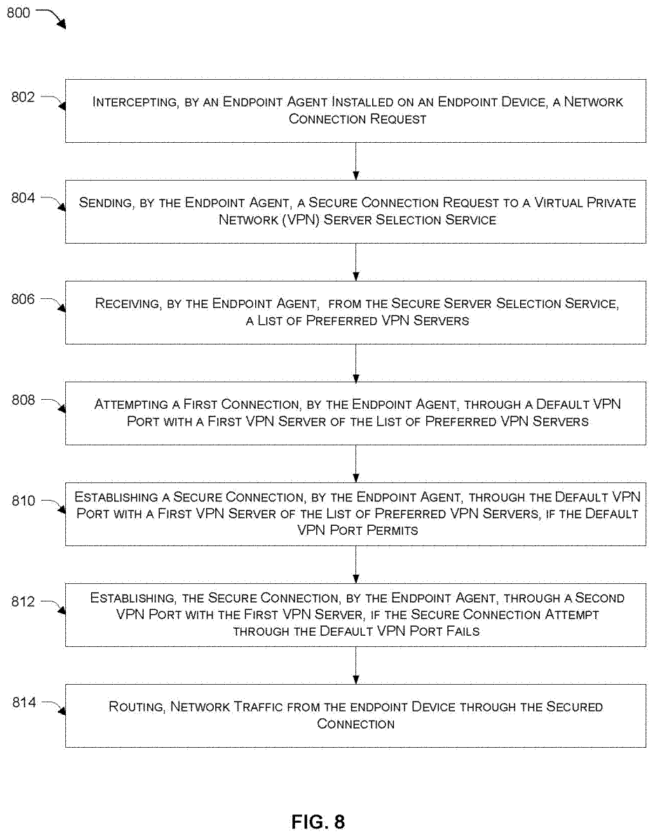

FIG. 8 is a flow diagram illustrating a process followed by an endpoint agent to provide a secure Internet connection in accordance with an embodiment of the present disclosure. In an embodiment, a method of establishing a secure connection between an endpoint device and a cloud-based security service includes the steps of intercepting, by an endpoint device, a network connection request, as shown at block 802, sending by the endpoint agent, a secure connection request to a VPN server selection service as shown at block 804, receiving, by the endpoint agent, from the VPN selection service a list of preferred VPN servers as shown at block 806, attempting a first connection by the endpoint agent, through a default VPN port with a first VPN server of the list of VPN servers as shown at block 808, and establishing the secure connection through the default VPN port with a first VPN server of the list of preferred VPN servers, if the default VPN port permits as shown at block 810. The method 800 further includes a step of establishing the secure connection by the secure endpoint agent through a second VPN port with the first VPN server, if the secure connection attempt through the default VPN port fails, as shown at block 812. The method 800 further includes a step of routing network traffic from the endpoint device through the secured connection, as shown at block 814.

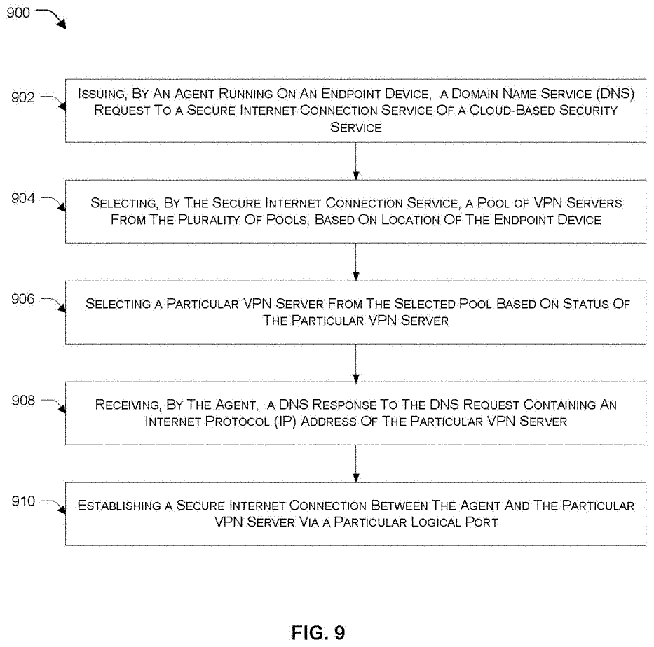

FIG. 9 is a flow diagram illustrating a process 900 involving both an endpoint agent and a secure Internet connection service to provide a secure Internet connection in accordance with another embodiment of the present disclosure. The process 900 includes steps of issuing by an agent running on an endpoint device, a domain name service (DNS) request to a secure Internet connection service of a cloud-based security service, as shown at block 902. In an embodiment, the secure Internet connection service includes a plurality of pools of geographically distributed virtual private network (VPN) servers. The process 900 further includes the steps of selecting, by the secure Internet connection service, a pool of VPN servers from the plurality of pools, based on the location of the endpoint device, as shown at block 904, and selecting a particular VPN server or particular set of VPN servers from the selected pool based on the status of the particular VPN server or the particular set of VPN servers, as shown at block 906. The process 900 further the includes steps of receiving, by the agent, a DNS response to the DNS request containing an Internet Protocol (IP) address of the particular VPN server or a set of IP addresses of the particular set of VPN servers as shown at block 908, and establishing a secure Internet connection between the agent and the particular VPN server or one selected from the particular set of VPN servers via a particular logical port as shown block 910.

In an embodiment, the agent tries different logical ports if a secure connection through the particular logical port is not successfully established. The agent selects a logical port of a plurality of logical ports and makes a connection attempt with a particular VPN server via the selected logical port until a connection attempt with the particular VPN server is successful. The agent prioritizes one or more well-known VPN ports over other ports for establishing a secure connection.

In an embodiment, the secure Internet connection service selects one or more particular VPN servers from the plurality of VPN servers based at least in part on a status maintained for each of the plurality of VPN servers of the pool and by selecting those in the best condition as indicated by their respective status values. The status of a particular VPN server may be determined based on a plurality of factors, including, but not limited to, a load on the particular VPN server, a health status of the particular VPN server, route congestion status from the endpoint device to the particular VPN server, and a number of active VPN connection at the particular VPN server.

In an embodiment, the secure Internet connection service receives the status of each of the plurality of VPN servers through stateful monitoring. In another embodiment, The secure internet connection service maintains an updated status of each of the plurality of VPN servers based on status updates received from stateful daemon associated with each of the plurality of VPN servers.

Various methods described herein may be practiced by combining one or more machine-readable storage media containing the code according to example embodiments described herein with appropriate computer hardware to execute the code contained therein. An apparatus for practicing various example embodiments described herein may involve one or more computing elements or computers (or one or more processors within a single computer) and storage systems containing or having network access to computer program(s) coded in accordance with various methods described herein, and the method steps of various example embodiments described herein may be accomplished by modules, routines, subroutines, or subparts of a computer program product.

FIG. 10 illustrates an exemplary computer system in which or with which embodiments of the present invention may be utilized. As shown in FIG. 10, a computer system includes an external storage device 1040, a bus 1030, a main memory 1015, a read-only memory 1020, a mass storage device 1025, a communication port 1010, and one or more processing resources (e.g., processing circuitry 1005). Computer system 1000 may represent some portion of an endpoint device (e.g., endpoint device 102 or 202), a VPN server (e.g., VPN server 106, 302, 410, or 602), a secure Internet connection service (e.g., VPN server selection service 104 or 502 or secure server selection service 404), or a monitoring service (e.g., global monitoring service 108 or 406 or global monitoring system 304).

Those skilled in the art will appreciate that computer system 1000 may include more than one processor and communication ports 1010. Examples of processing circuitry 1005 include, but are not limited to, an Intel® Itanium® or Itanium 2 processor(s), or AMD® Opteron® or Athlon MP® processor(s), Motorola® lines of processors, FortiSOC™ system on chip processors or other future processors. Processing circuitry 1005 may include various modules associated with embodiments of the present invention.

Communication port 1010 can be any of an RS-232 port for use with a modem-based dialup connection, a 10/100 Ethernet port, a Gigabit or 10 Gigabit port using copper or fiber, a serial port, a parallel port, or other existing or future ports. Communication port 1010 may be chosen depending on a network, such as a Local Area Network (LAN), Wide Area Network (WAN), or any network to which the computer system connects.

Memory 1015 can be Random Access Memory (RAM), or any other dynamic storage device commonly known in the art. Read-Only Memory (ROM) 1020 can be any static storage device(s) e.g., but not limited to, a Programmable Read-Only Memory (PROM) chips for storing static information e.g. start-up or BIOS instructions for processing circuitry 1005.

Mass storage 1025 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 1030 communicatively couples processing circuitry 1005 with the other memory, storage, and communication blocks. Bus 1030 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processing circuitry 1005 to a software system. In no way should the aforementioned exemplary computer system limit the scope of the present disclosure.

While embodiments of the present invention have been illustrated and described, it will be clear that the invention is not limited to these embodiments only. Numerous modifications, changes, variations, substitutions, and equivalents, will be apparent to those skilled in the art without departing from the spirit and scope of the invention, as described in the claims.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Their respective functions may be carried out through the operation of program logic, through dedicated logic, through the interaction of program control and dedicated logic. Those of ordinary skill in the art further understand that the exemplary hardware, software, processes, methods, and/or operating systems described herein are for illustrative purposes and, thus, are not intended to be limited to any explicitly called out herein.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

What is claimed is:

1. A method performed within an agent running on an endpoint device by a processing resource of the endpoint device, the method comprising:
issuing a domain name service (DNS) request to a secure Internet connection service of a cloud-based security service, wherein the secure Internet connection service includes a plurality of pools of geographically distributed virtual private network (VPN) servers;
receiving a DNS response to the DNS request containing an Internet Protocol (IP) address of a particular VPN server within a pool of the plurality of pools, wherein the pool is selected by the secure Internet connection service based at least in part on a geographic location of the endpoint device inferred by a source IP address of the DNS request, and wherein the particular VPN server is selected from a plurality of VPN servers in the pool based on a status of the particular VPN server; and
establishing a secure Internet connection between the agent and the particular VPN server via a particular logical port.

2. The method of claim 1, wherein the DNS response contains a set of IP addresses of a set of VPN servers within the pool and wherein the method further comprises selecting the particular VPN server from the set of VPN servers.

3. The method of claim 1, wherein the secure Internet connection service selects the set of VPN servers from the plurality of VPN servers, by actively monitoring a health status of each of the plurality of VPN servers of the pool and selecting those of the plurality of VPN servers that are most healthy as indicated by their respective health status.

4. The method of claim 1, wherein said establishing comprises until a connection attempt with the particular VPN server is successful:
selecting a logical port of a plurality of logical ports; and
making a connection attempt with the particular VPN server via the selected logical port.

5. The method of claim 4, wherein said selecting prioritizes one or more well-known VPN ports over other ports.

6. The method of claim 1, wherein the status of the particular server is determined based on any or combination of health status, compliance regulations, and status of connections with one or Internet service providers.

7. The method of claim 1, wherein the pool is selected by the secure Internet connection service based at least in part on the geographic location of the endpoint device and a compliance regulation of a country.

8. The method of claim 1, further comprising routing network traffic originated by the endpoint device through the secure Internet connection.

9. The method of claim 1, wherein the status of the particular VPN server is determined based on a plurality of factors including one or more of a load on the particular VPN server, route congestion status from the endpoint device to the particular VPN server, and a number of active VPN connections at the particular VPN server.

10. A method performed by one or more processing resources of one or more computer systems supporting a secure Internet connection service, the method comprising:
receiving a domain name service (DNS) request at the secure Internet connection service of a cloud-based security service from an agent running on an endpoint device, wherein the secure Internet connection service includes a plurality of pools of geographically distributed virtual private network (VPN) servers;
sending a DNS response to the DNS request containing an Internet Protocol (IP) addresses of a particular VPN server within a pool of the plurality of pools to the endpoint device, wherein the pool is selected by the secure Internet connection service based at least in part on a geographic location of the endpoint device inferred by a source IP address of the DNS request, and wherein the particular VPN server is selected from a plurality of VPN servers in the pool based on a status of the particular VPN server; and
establishing a secure Internet connection between the agent and the particular VPN server via a particular logical port.

11. The method of claim 10, wherein the DNS response contains a set of IP addresses of a set of VPN servers within the pool and wherein the secure Internet connection service selects the set of VPN servers from the plurality of VPN servers, by actively monitoring a health status of each of the plurality of VPN servers of the pool and selecting those of the plurality of VPN servers that are most healthy as indicated by their respective health status.

12. The method of claim 10, wherein the status of the particular server is determined based on any or combination of health status, compliance regulations, and status of connections with one or Internet service providers.

13. The method of claim 10, wherein the pool is selected by the secure Internet connection service based at least in part on the geographic location of the endpoint device and a compliance regulation of a country.

14. The method of claim 10, wherein the status of each of the plurality of VPN servers is determined through stateful monitoring informed by local components of the cloud-based security service.

15. The method of claim 10, wherein the status of each of the plurality of VPN servers is updated based on status updates received from a stateful daemon associated with each of the plurality of VPN servers.

16. The method of claim 10, wherein faster connectivity is provided to users of the cloud-based security service by each VPN server of the pool of VPN servers being connected to a network backbone having a plurality of established peer connections providing direct access to a plurality of networks.

17. The method of claim 10, wherein the status of the particular VPN server is determined based on a plurality of factors including one or more of a load on the particular VPN server, route congestion status from the endpoint device to the particular VPN server, and a number of active VPN connections at the particular VPN server.

18. An endpoint device comprising:
a processing resource; and
a non-transitory computer-readable medium, coupled to the processing resource, having stored therein instructions that when executed by the processing resource cause the processing resource to:
issue a domain name service (DNS) request to a secure Internet connection service of a cloud-based security service, wherein the secure Internet connection service includes a plurality of pools of geographically distributed virtual private network (VPN) servers;
receive a DNS response to the DNS request containing an Internet Protocol (IP) address of a particular VPN server within a pool of the plurality of pools, wherein the pool is selected by the secure Internet connection service based at least in part on a geographic location of the endpoint device inferred by a source IP address of the DNS request, and wherein the particular VPN server is selected from a plurality of VPN servers in the pool based on a status of the particular VPN server; and
establish a secure Internet connection between the endpoint device and the particular VPN server via a particular logical port.

19. The endpoint device of claim 18, wherein the DNS response contains a set of IP addresses of a set of VPN servers within the pool and wherein the instructions further cause the processing resource to select the particular VPN server from the set of VPN servers.

20. The endpoint device of claim 18, wherein the secure Internet connection service selects the set of VPN servers from the plurality of VPN servers, by actively monitoring a health status of each of the plurality of VPN servers of the pool and selecting those of the plurality of VPN servers that are most healthy as indicated by their respective health status.

21. The endpoint device of claim 18, wherein establishment of the secure Internet connection includes until a connection attempt with the particular VPN server is successful:
selecting a logical port of a plurality of logical ports; and
making a connection attempt with the particular VPN server via the selected logical port.

22. The endpoint device of claim 21, wherein said selecting prioritizes one or more well-known VPN ports over other ports.

23. The endpoint device of claim 18, wherein the status of the particular server is determined based on any or combination of health status, compliance regulations, and status of connections with one or Internet service providers.

24. The endpoint device of claim 18, wherein the pool is selected by the secure Internet connection service based at least in part on the geographic location of the endpoint device and a compliance regulation of a country.

25. The endpoint device of claim 18, wherein the instructions further cause the processing resource to route network traffic originated by the endpoint device through the secure Internet connection.

26. The endpoint device of claim 18, wherein the status of the particular VPN server is determined based on a plurality of factors including one or more of a load on the particular VPN server, route congestion status from the endpoint device to the particular VPN server, and a number of active VPN connections at the particular VPN server.

27. A system comprising:
a processing resource; and
a non-transitory computer-readable medium, coupled to the processing resource, having stored therein instructions that when executed by the processing resource cause the processing resource to:
receive a domain name service (DNS) request on behalf of a secure Internet connection service of a cloud-based security service from an agent running on an endpoint device, wherein the secure Internet connection service includes a plurality of pools of geographically distributed virtual private network (VPN) servers;
send a DNS response to the DNS request containing an Internet Protocol (IP) addresses of a particular VPN server within a pool of the plurality of pools to the endpoint device, wherein the pool is selected by the secure Internet connection service based at least in part on a geographic location of the endpoint device inferred by a source IP address of the DNS request, and wherein the particular VPN server is selected from a plurality of VPN servers in the pool based on a status of the particular VPN server; and
establish a secure Internet connection between the agent and the particular VPN server via a particular logical port.

28. The system of claim 27, wherein the DNS response contains a set of IP addresses of a set of VPN servers within the pool and wherein the instructions further cause the system to select the set of VPN servers from the plurality of VPN servers, by actively monitoring a health status of each of the plurality of VPN servers of the pool and selecting those of the plurality of VPN servers that are most healthy as indicated by their respective health status.

29. The system of claim 27, wherein the status of the particular server is determined based on any or combination of health status, compliance regulations, and status of connections with one or Internet service providers.

30. The system of claim 27, wherein the pool is selected based at least in part on the geographic location of the endpoint device and a compliance regulation of a country.

31. The system of claim 27, wherein the status of each of the plurality of VPN servers is determined through stateful monitoring informed by local components of the cloud-based security service.

32. The system of claim 27, wherein the status of each of the plurality of VPN servers is updated based on status updates received from a stateful daemon associated with each of the plurality of VPN servers.

33. The system of claim 27, wherein faster connectivity is provided to users of the cloud-based security service by each VPN server of the pool of VPN servers being connected to a network backbone having a plurality of established peer connections providing direct access to a plurality of networks.

34. The system of claim 27, wherein the status of the particular VPN server is determined based on a plurality of factors including one or more of a load on the particular VPN server, route congestion status from the endpoint device to the particular VPN server, and a number of active VPN connections at the particular VPN server.
